(19) United States
(12) Patent Application Publication
(10) Pub. No.: US 2024/0016691 A1
(43) Pub. Date: Jan. 18, 2024

(54) MASSAGE ROBOT

(71) Applicant: ADAMO ROBOT, S.L., Logrono (ES)

(72) Inventor: Alfredo Sanchez Jimenez, Logrono (ES)

(73) Assignee: ADAMO ROBOT, S.L., Logrono (ES)

(21) Appl. No.: 17/812,501

(22) Filed: Jul. 14, 2022

(51) Int. Cl. A61H 9/00; A61G 13/00; B25J 9/00; B25J 19/02

(52) U.S. Cl. CPC A61H 9/0071; A61G 13/009; B25J 9/0009; B25J 19/022; B25J 19/023; A61H 2201/0207; A61H 2201/1659; A61H 2201/5064; A61H 2201/5092; A61H 2201/0188

(57) ABSTRACT

A massage robot having a support casing (1) with at least one arm (2) ending in a manipulator (3). The manipulator (3) includes at least one nozzle (4) for pressurized hot air connected to a compressor and at least one camera (6,7) for observation of a patient. The camera (6,7) is selected from a volumetric and video camera (6), a thermographic camera (7). The manipulator (3) may also includes a distance sensor (8), and preferably a laser pointer (11).

### FIELD OF THE INVENTION

The present invention refers to a robot that can treat musculoskeletal pathologies through thermoregulated compressed air. It has a robotic arm, which, through a manipulator, produces, with the jet of compressed air, a mechanical pressure on the patient's tissue, emulating manual therapy. The air can be heated or cooled using the most appropriate thermotherapy for the pathology or clinical objective.

### BACKGROUND OF THE INVENTION

Many pathologies, such as back pain, can be corrected or reduced with proper physiotherapy treatment. Thus, spinal pain (cervical pain, back pain, lumbago . . . ), neck pain . . . caused by stress or poor posture or movement, repetitive use of muscles . . . or muscle sprains or strains.

Some of these pathologies cause ischemia, areas of poor blood supply, and the consequent pain. Later, the ischemic zones develop into fibrous nodules that restrict the mobility and functionality of the zone. Likewise, other pathologies, such as sprains, trauma, or post-surgical recovery, generate inflammation, accumulation of waste substances.

The treatment is carried out manually by the health professional and it is not measurable in intensity, nor in the pressure exerted nor in the exact location, since from one day to the next or from one professional to another. When the same patient is treated, many factors can vary such as the location of the point, the intensity, types of movement, speed and application time, etc. This implies that there is no traceability of the massages performed and of the evolution of the injury or discomfort.

The applicant does not know of any robot that can be considered equivalent to the invention, as no invention is known in the world that is equal to or sufficiently similar to the proposed robot.

### SUMMARY OF INVENTION

The present invention is a massage robot comprising a robotic arm, one or more cameras, for example thermographic or volumetric, and a nozzle for expelling thermoregulated (both hot and cold) compressed air that performs the treatment on the patient.

It allows creating a treatment parameterized by the health professional or operator in the first session, according to the prescribed pathology, intensity, and duration. This treatment will be repetitive and individualized under the same parameters configured in future sessions, even if the therapist is no longer present.

This robot makes it possible to shorten waiting lists for treatment, in addition to reduce healing times, by being able to schedule more and higher quality sessions. In addition, as there is no direct contact, even very acute cases can be treated where the patient cannot bear contact with the therapist's hand.

The treatments performed by this device are optimal for a multitude of pathologies. Thanks to the pressure and temperature regulation it is possible to treat a multitude of pathologies, among which are described: Myofascial trigger points (MTP) (active and latent), Back pain (cervical, upper and lower), Muscle contractures, Whiplash Injury (cervical sprain), Muscle and ligament strains, Menstrual pain Pathologies in which the therapist cannot contact patient skin, Fascial problems, Fibromyalgia, Bruises, Strokes, Sprains, Tendinopathy, etc.

Accordingly, the massage robot comprises a support casing with at least one arm ending in a manipulator. This manipulator comprises at least one nozzle for blowing pressurized thermoregulated (hot and cold air) connected to a compressor, and at least one camera for observation of a patient. The camera may be selected from a volumetric camera, a thermographic camera and/or a video camera.

### DESCRIPTION OF THE DRAWINGS

For a better understanding of the invention, a set of figures is provided representing a non-limiting example of embodiment.

FIG. 1: general view of the robot, according to a first embodiment;

FIG. 2: detail of the manipulator; and

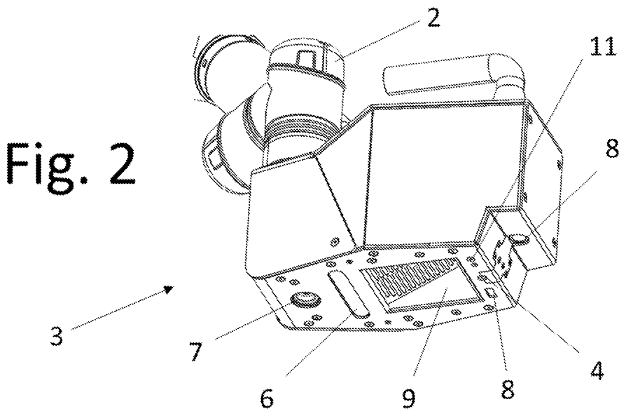

FIG. 3: procedure carried out by the software.

### DETAILED DESCRIPTION OF THE INVENTION

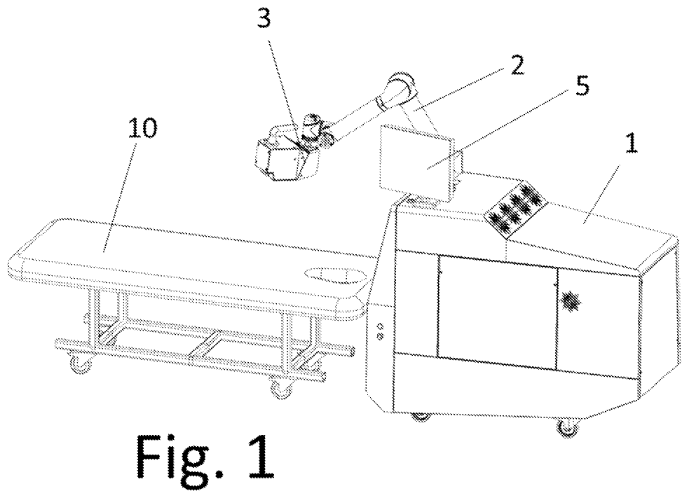

The robot of the example of embodiment of FIG. 1 is made of a support casing (1) or column, which can be static or have means for its movement, such as wheels. The casing (1) has at least one robotic arm (2) ending in a manipulator (3) with at least one treatment nozzle (4) that expels hot pressurized air to carry out the pressure on the work points. That is, the robot works by compressed air, and therefore includes one or more compressors, valves, pressure gauges . . . ventilation grills, access doors to the interior, etc. The air can be heated by one or more resistors, monitored by thermometers so the temperature is within a comfortable range. The air pressure will generally be 6 to 9 bars, and may be lower if the injury is already in the recovery phase, for children's treatments, geriatrics.

The casing (1) carries a display (5) with the interface for the therapist to give the appropriate orders. This display (5) is preferably tactile. Other interfaces are possible, but less preferred.

The manipulator (3) also includes a volumetric camera (6), a thermographic camera (7) and a distance sensor (8). The three-dimensional volumetric camera (6), together with the thermographic camera (7), detects the patient's position, shape and points temperature for more effective treatment. The operation of three-dimensional cameras is based on the acquisition of images from two or more different angles, being able to recognize the volume of the body to be studied. Some commercial examples of the volumetric camera are the Astra S Somatosensory, Intel RealSense or Omron—FZD 3D Vision camera. On the other hand, thermal cameras detect temperature by capturing different levels of infrared light, invisible to the human eye, which is radiated by objects. The hotter an object is, the more infrared radiation it produces. Thermal cameras can detect this radiation and convert it into an image. Some examples of this type of thermal cameras are those marketed by brands such as Fluke, Flir or Fotric. The thermographic camera used works in wide temperature ranges (depending on the setting, but preferably from 0° C. to 60° C.) and has sufficient image quality to detect the temperature changes typical of the musculoskeletal pathologies to be treated.

In this way, the device is able to modify the treatment points and measure the changes, and it can follow and study the pathology throughout the treatment. All these elements are located inside the manipulator (3) or nearby. A comfort air outlet (9) allows the patient to be heated without the pressure corresponding to the nozzle (4). In one embodiment, the distance sensor (8) has a close detection part and a measurement part. The close detection avoids the contact between the patient and the robot.

There are multiple types of proximity sensors with different functions. Some types are inductive, capacitive, magnetic, ultrasonic or photoelectric. The use of each of them depends on the measuring distance and the type of material to be measured.

In this case, since the patient's skin is involved, photoelectric or ultrasonic sensors are the most suitable, but the use of other modalities is not excluded. Ultrasound sensors calculate the distance based on the time it takes to travel the distance and bounce off the object. This is a sound that is not audible to human hearing. Photoelectric sensors emit a light, usually infrared, and detect the angle of reflection from the surface to be measured. The greater the distance, the smaller the angle measured. Both types of sensors can measure distances with a range from 3 to 200 cm, ideal for the intended application. Some of the most popular manufacturers are Festo, Siemens or Omron.

The nozzles (4) may have a diameter of nearly 3 mm and, in use, are positioned a few centimeters (e.g., 3 cm) from the user's skin. In this way, the zone of influence of the jet has a diameter of about 4 cm. The comfort air outlet (9) may have a bigger size, for example 5×7 cm from the skin, so the air does not produce pressure on the skin but heats it.

The robot is placed next to one or more stretchers (10) where the patient is placed. The stretchers (10) will be ergonomic so that the patient may need to move as little as possible. Thus, they can have a hole for the head and two upper supports for the forearms, among other options. In this way, the patient can be positioned in different ways (lying, sitting or sideways) without moving throughout the treatment.

A commercial robot can be used, with the necessary certifications, such as the human-machine interaction regulations. For example, the Universal Robot UR5 collaborative manipulator robot is considered very suitable, with the programming and accessories described.

The aforementioned robot has torque sensors integrated in its joints, which can be used for manual guidance performed by the physiotherapist and also to react avoiding damage to the patient in the event of direct contact with the robot.

The therapist will be able to modify the temperature, outlet pressure through the nozzle (4), mark the points on the patient's back (in an image on the display (5) or on the skin with an optically recognizable mark). In one embodiment, the manipulator has a laser pointer (11) that also serves for the therapist to observe the area where the nozzle (4) points and save that position in the robot's memory so that it can perform the treatment there later.

Thus, the therapist can control the treatments, the pressure exerted according to the patient's tolerance . . . . It is possible to save an image of the patient's back so that the robot can recognize the different points for future treatments.

The distance sensor (8) ensures that the same distance is always maintained from the patient, without actually touching him and maintaining a safety distance. This allows the robotic arm, together with the head, to dynamically adapt to the patient's body shape and possible movements during treatment.

The volumetric camera (6) is installed near the end of the manipulator (3). Since the compressed air must be applied perpendicularly to the point of contact, the stereoscopic or volumetric camera (6) measures the contour and volume of the patient to perform the therapy, thus defining the perpendicular to his skin at the point of treatment. This volumetric camera (6) can, through software, define the exact position of the patient at the beginning of the session. If the patient has moved in subsequent sessions, the robot will adapt based on the new images and coordinates of the patient, matching the data from the first session. It can also be based on the position of recognizable elements, such as moles, to fix the coordinates of each position.

This position should be the same in different sessions. Thanks to the peripheral vision of the system obtained by the cameras (6, 7) and regulated by means of the laser pointer and images, the robot adapts to the patient once he is placed on the stretcher (10).

The points marked for the treatment are not located using global coordinates of the system, but relative to the position of the patient's body, since it is very difficult for the patient to be in exactly the same position in all the sessions. For this, the marked treatment points are associated with the body model (profile or skeleton) of the patient in the first session recorded by the therapist.

In addition to the points of application of the treatment, the device allows the health professional to adapt the treatment to the specific case. Thus, parameters such as the temperature, location and pressure of the air expelled, the types of movements made by the head and their speed, the intensity of the air flow, etc. can be varied according to the pathology and the mode of application previously chosen by the health professional.

The thermographic camera (7) integrated in the manipulator (3) will be used by the therapist to contrast the temperature difference at the point of treatment, storing the corresponding images in each session to see its evolution and be able to document the improvement throughout the use of the robot. From these data, artificial intelligence models (deep learning) can be created based on a bank of images and clinical, anthropometric and sociodemographic data, applicable in the programming of the robot. Examples of data are gender, age, type of injury, area of pain, and general health records: personal and family history, lifestyles, anthropometric information such as height, weight, and body mass index. These models will be able to objectify and provide the therapist with prediagnosis, estimation of recovery time, treatment . . . . They can also provide the identification of the asymmetrical area of the patient's musculoskeletal tissue, under analysis of the symmetrical thermographic images database.

The objective of the model is the prognosis of the musculoskeletal pathology. As it is working with structured data (sociodemographic variables) and images (thermographic), the architecture of the model is hybrid. On the one hand, a multilayer perceptron is created that works with the structured data. The other part is a convolutional network that allows good image processing. To carry out the final classification of both models, strategies such as evolutionary algorithms or reinforcement learning are needed. To find the most efficient model possible, a “grid search” strategy is applied, which allows different models to be trained by testing different values of the hyperparameters.

The training will be carried out from an anonymized training image set where thermal pictures of the relevant parts of the body, where a diagnosis has been attained and the trigger points located, are introduced in a database (e.g. on hundred participants). This data will comprise social and physical variables (age, height, weight, gender . . . so the model will take those into account. Then the artificial vision system is developed using machine learning algorithms especially effective in computer vision field. The referral image set will be the same as the training set. Then the final version of the algorithm is trained using different folds of the training set to validate the results, with the excluded subjects as a cross-validation methodology. Those results will be considered to modify some model parameters if these modifications would be needed to increase algorithm effectivity.

In order to test the prediction model using the robot units, the prediction model will be installed and be available to patients and users to continue trials. This might require several modifications on the different apps and APIs (back-end and front-end) of which the system is composed. Once the modifications are finished, the model will be deployed in the robots and tested in an unicentric, double-arm, single-blinded, randomized controlled clinical trial.

On the other hand, the invention is not only focused on the treatment of existing pathologies, but also on prevention before they occur. With elements such as the thermographic camera and the software used (Artificial Intelligence), it is possible to detect whether a muscle is vascularized to a greater or lesser extent and decide whether the device should act. A possible but not unique case would be, some kind of intervention or activity has to be performed, the inflammation or spasticity of a muscle or limb can be detected in advance. In this way, a patient can be prepared or prevented for future medical and sport activities.

The arm (2) can be moved freely by the therapist, for which it deactivates its motors when required, either to mark the points or to make an exploration with the thermographic camera (7).

In use, the treatment starts with the comfort air outlet (9), making a tour of the treatment points (normally four per session). Once the comfort phase is over, the treatment begins with pressurized air through the nozzle (4), gradually increasing the pressure. the time of treatment, as well as its mode, is completely variable. These parameters, among others, will depend on the area to be treated and the patient's condition, all supervised by the medical professional.

The device is primarily developed for collaborative use with the help of the medical specialist. However, due to the series of cameras, external sensors and the software in charge of operating the treatments, it is able to act in a safe, autonomous, unattended way.

The main elements of the software used to control the system and its functionalities are described below. In one embodiment, the main hardware elements employed are:

Remote database. This consists of a cloud computing service, to primarily store data and the other services information offered.

Computer (PC). It is the main component of the assembly. It receives signals from the operator and controls the rest of the components in the robot.

Machine controller or PLC (Programmable Logic Controller). It is an industrial computer control system that continuously monitors the state of input devices and makes decisions based on a custom program. This element is also in charge of monitoring all the signals from the sensors, as well as the movements of the robotic arm.

Collaborative robot arm. The industrial robotic arm used is lightweight, flexible and collaborative. This makes it possible to automate repetitive tasks such as the one in question, with a payload at the tip sufficient to support the weight of the multifunction handpiece.

Different sensors (such as the 3D or volumetric camera, the thermographic camera or proximity sensor) and also actuators, as the air compressor or the ceramic heater.

In this embodiment, the process starts with the operator or therapist indicating on the PC the treatment to be followed and the different characteristics. All elements are connected via physical cable, and communication is usually established in both directions.

First of all, they start by recording the patient's data and the pathology presented. Next, the volumetric camera scans the area to be treated. In addition, temperature information is obtained due to the thermographic camera. These steps are carried out on the PC through the User Interface (Ui) and User Experience (Ux).

After indicating the type of treatment, the operator activates the free-driving mode and marks the points, with the manipulator and the laser pointer, where the treatment is to be performed. When the physiotherapist indicates the point, the machine controller receives the button signal and reads the position of the arm. These points information, with three-dimensional coordinates and rotation angles, are stored in the controller memory and are also stored in the cloud.

All this information, such as patient data, application points or the thermographic image, is stored in online databases. For this purpose, different Application Programming Interfaces (APIs) are used to organize and protect the collected data.

Once all the treatment information has been established, the PC sends the operating commands to the PLC. When the treatment is started, the PLC controls the robotic arm, sending the information about the application points, speed and type of treatment.

The robotic arm treats the patient at the distance set by the physio, without physical contact at any time. The robotic arm head is equipped with different sensors to ensure this distance. If any kind of contact is detected, either by the proximity sensors or by the robotic arm itself, the signal is sent to the PLC, the process is stopped and the arm moved away.

In case the patient has already received a previous treatment, the physiotherapist will not have to mark the application points again. In this case, the patient should be placed in a position similar to the previous time. The physiotherapist initiates the process, and the PC orders the PLC to send the robotic arm to the home position. The robot will again take a thermographic image and a 3D photo of the patient.

Taking as a reference both the actual 3D image and the saved positions of previous treatments, the system calculates the application points with the new position. In this way, the treatment is replicated as many times as needed, even if the patient's position changes. The rest of the process continues as originally established, with the information stored and retrieved from the cloud database.

The number of ethernet connections may require an additional communication system. An ethernet switch is used for this purpose. This component is an in-memory data structure store, and is used as database, cache and message intermediary. The entire communication is also controlled by an API. Both thermographic and 3D cameras are also connected to this switch.

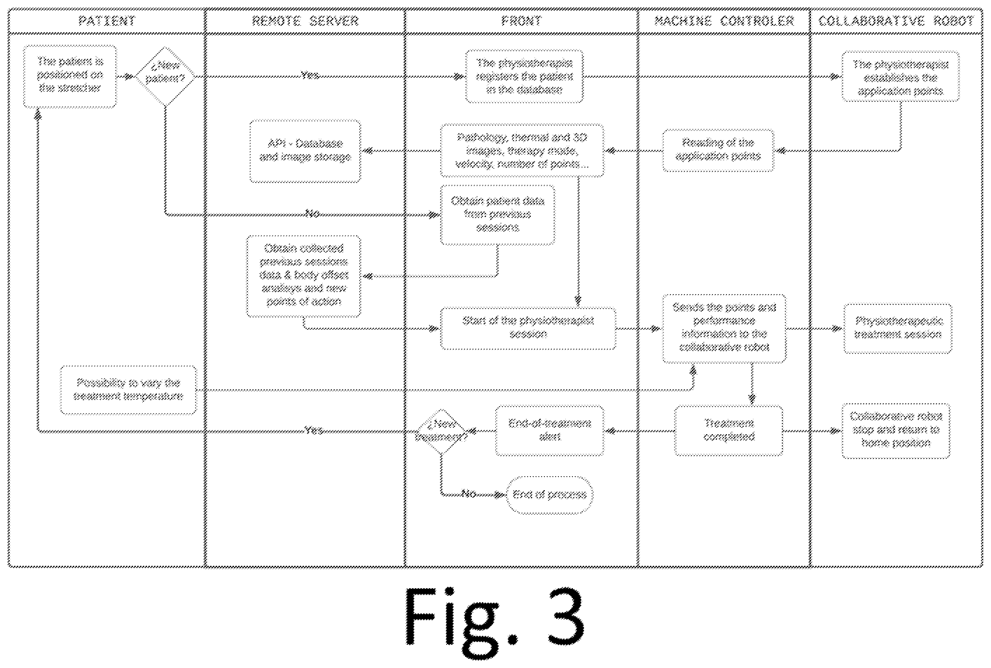

The whole process explained above is shown in the action process diagram shown in FIG. 3.

This compressed air treatment can be applied to a wide variety of areas, such as the cervical, back, lumbar or extremities. The system also offers different operating modes, including:

Point by point. This first treatment mode is characterized by the discontinuous application of compressed air. The head is positioned at a certain distance from the point of application, the compressed air starts through the nozzle and descends to the programmed point. After acting statically for a programmed time, the compressed air stops and the arm withdraws to the safety point and advances to the next point. This process is repeated for each point continuously, and the treatment time and temperature can be varied.

Arch. In this second mode, the head approaches the safety distance from the first point, starts blowing and approaches the treatment point. After the time has passed, the head moves directly to the next points without stopping blowing. The head, due to the proximity sensor, always maintains a minimum distance to the patient to avoid contact. When the treatment is completed, the treatment is finished and the robotic arm is withdrawn.

Linear. In linear mode, the spindle follows the same procedure as above. However, a number of loops can be set, being able to go through all the set points as many times as the physiotherapist considers. Both arch and linear modes are intended to simulate linear and unidirectional movements performed by the physiotherapist.

Pendulum. In this last operating mode, the head follows the same steps as in the linear mode. However, once it has reached the last treatment point, the robotic arm returns to the reverse path. This back-and-forth pattern through the identified points can be repeated as many times as desired by setting a number of loops.

Each of these modes of operation has advantages depending on the pathology to be treated and the area in which it is located.

1. A massage robot comprising:
a support casing (1) with at least one arm (2) ending in a manipulator (3),
wherein the manipulator (3) comprises at least one nozzle (4) for pressurized thermoregulated air connected to a compressor and at least one camera (6,7) or proximity sensor for observation of a patient.

2. The massage robot, according to claim 1, wherein the at least one camera (6,7) is selected from a volumetric camera (6), a thermographic camera (7), or a video camera.

3. The massage robot according to claim 1, further comprising a distance sensor (8) in the manipulator (3).

4. The massage robot according to claim 1, further comprising a laser pointer (11).

5. The massage robot according to claim 1, further comprising a stretcher (10).

6. The massage robot according to claim 1, further comprising a comfort air outlet (9) for hot air, parallel or through the nozzle (4).
